(19) United States
(12) Patent Application Publication
(10) Pub. No.: US 2026/0077358 A1
(43) Pub. Date: Mar. 19, 2026

(54) Pipette Tip Support Card Bundles

(71) Applicant: Xcaliber Sciences, Inc., San Diego, CA (US)

(72) Inventors: Arta Motadel, Rancho Santa Fe, CA (US); Pete Blaszcak, Ramona, CA (US); Juan Martin Mendez Padilla, Tijuana (MX)

(21) Appl. No.: 19/394,094

(22) Filed: Nov. 19, 2025

Related U.S. Application Data
(63) Continuation of application No. 18/620,627, filed on Mar. 28, 2024, now Pat. No. 12,515,227.
(60) Provisional application No. 63/614,919, filed on Dec. 27, 2023.
(60) Provisional application No. 63/567,766, filed on Mar. 20, 2024.

(51) Int. Cl. B01L 9/00

(52) U.S. Cl. CPC B01L 9/543; B01L 2200/025; B01L 2300/045

(57) ABSTRACT

An interleaved pipette tip support card bundle includes two or more support cards arranged with their top surfaces facing outward and their pipette tips extending inward to interleave without contact. Each support card includes receiver slots in its bottom surface that are coaxially aligned with support holes of an opposing card and sized to receive distal ends of opposing pipette tips with clearance, preventing tip-to-tip and tip-to-card contact and reducing static buildup. Each card may further include a reduced-height apron whose distal edge abuts the distal edge of an opposing apron to set the card spacing while permitting full interleaving. Arrays of pipette tip support holes on opposing cards are offset to maximize packing density. Multi-pair bundles, including four- and six-card configurations, provide compact, low-volume assemblies suitable for efficient shipping, storage, and automated or manual pipette tip loading.

### CROSS-REFERENCE TO RELATED APPLICATIONS

This application is a continuation of U.S. application Ser. No. 18/620,627, filed Mar. 28, 2024, which claims priority to U.S. Provisional Application No. 63/614,919 (filed Dec. 26, 2023) and U.S. Provisional Application No. 63/567,766 (filed Mar. 20, 2024), all entitled “Pipette Tip Support Card Bundles.” The entire contents of these applications are incorporated herein by reference.

This application also relates to U.S. Pat. No. 11,701,663 (issued Jul. 18, 2023), incorporated herein by reference in its entirety.

### FIELD OF THE INVENTION

The invention relates to laboratory consumables, and more particularly to pipette tip support cards (also referred to as trays, decks, or racks) and bundled configurations of such cards for compact shipping, storage, and automated or manual pipette tip loading.

### BACKGROUND OF THE INVENTION

Disposable pipette tips are routinely supplied in rigid support cards or racks containing an array of holes (for example 96, 384, or 1536 holes) that hold the tips in a vertical orientation. To facilitate tip insertion and removal, the support holes are typically oversized relative to the tips. While convenient, this oversizing allows lateral movement of the tips during shipping and handling. Adjacent tips can rub against one another, generating static electricity and causing the tips to become misaligned within the holes.

Tip misalignment complicates reliable mating of manual and automated pipettors with the tips. Automated systems in particular expect each tip to be centered within its corresponding hole. Static-induced misalignment can therefore cause failed pickups, poor or inconsistent sealing, inaccurate dispensing, or complete system errors that interrupt automated workflows.

Conventional packaging practice is to ship pipette tip support cards as individual units, either individually wrapped or placed in separate boxes. When multiple individually packaged cards are placed in a larger shipping container, they inevitably jostle against one another in transit. This motion exacerbates tip-to-tip contact within and between cards, further increasing static buildup and misalignment.

In addition, many support cards incorporate full-height aprons or skirts that extend downward from the card to elevate the tips above the laboratory bench and reduce contamination risk. Although functional, such tall aprons significantly increase the overall height of each loaded card, leading to larger shipping volumes, higher freight and packaging costs, and increased plastic waste.

Accordingly, there is a need for pipette tip support card systems that reduce tip-to-tip contact and static buildup during shipping and handling, maintain precise tip alignment for automated and manual loading, and significantly reduce overall shipping volume and materials usage.

### SUMMARY OF THE INVENTION

The invention provides interleaved pipette tip support card bundles in which pairs of support cards are oriented with their top surfaces facing outwardly and their pipette tips extending inwardly toward one another. The pipette tips from opposing cards interleave without contact, and distal ends of the pipette tips are received in receiver slots formed in bottom surfaces of the opposing cards. The receiver slots provide clearance around the distal ends so that the tips do not contact the opposing card, thereby substantially eliminating tip-to-tip and tip-to-card contact during shipping and handling and greatly reducing static buildup.

Each support card may include an apron extending away from the top surface in the same direction as the pipette tips. The aprons extend a distance less than the extension length of the tips so that, when two cards are interleaved, distal edges of the aprons abut one another to define a precise spacing between cards while the tips extend past the distal edges. The resulting bundle height is only slightly greater than the height of a single loaded card plus one tip length, dramatically reducing shipping volume relative to individually boxed cards.

The support hole arrays on opposing cards are longitudinally and laterally offset to provide dense interleaving of the pipette tips without interference. Receiver slots in the bottom surface of each card are coaxially aligned with support holes in the opposing card in the assembled bundle so that distal ends of the opposing tips are captured with clearance inside the receiver slots.

Bundles comprising four or six support cards can be formed from two or three such interleaved pairs. The pairs are oriented substantially orthogonally (for example rotated by about) 90° relative to one another to form a generally cubic or near-cubic bundle footprint. Such multi-card bundles can reduce shipping volume by more than 60% compared with conventional individually boxed support cards of an equivalent tip count.

In some embodiments, one or more support cards include sliding, snap-fit, or hinged lids configured to cover the top surface and retain the pipette tips in their support holes. Peripheral cutouts or partial holes along at least one edge provide an unobstructed region that permits a multi-channel pipettor to access a subset of tips in a row without interference from the card edge. The support cards may be formed from anti-static or static-dissipative polymers to further mitigate static buildup during shipping and use.

Additional aspects, alternatives, and variations will be apparent to persons of ordinary skill in the art in view of the present disclosure. The invention is defined solely by the claims as allowed, and the summary above is provided to introduce certain example embodiments and is not intended to limit the scope of the claims.

### BRIEF DESCRIPTION OF THE DRAWINGS

The invention can be better understood with reference to the following figures. The components in the figures are not necessarily to scale, emphasis instead being placed on clearly illustrating example aspects of the invention. Like reference numerals designate corresponding parts throughout the different views and embodiments. Various features of different disclosed embodiments may be combined to form additional embodiments, which are also part of this disclosure.

FIG. 1A is a top isometric view of an interleaved support card bundle comprised of two pipette tip support cards, with covers partially opened to expose a plurality of pipette tips.

FIG. 1B is a perspective view of a pipette tip support card removed from the bundle illustrating a plurality of peripheral partial holes or cutouts along its edge, configured to prevent interference with a multi-channel pipettor when loading pipette tips.

FIG. 1C is a bottom isometric view of an interleaved support card bundle comprised of two pipette tip support cards.

FIG. 1D is a bottom isometric view of an interleaved support card bundle comprised of two pipette tip support cards, with the aprons removed.

FIG. 1E is a short-side view of an interleaved support card bundle comprised of two pipette tip support cards, with the aprons removed, showing interleaving of the pipette tips.

FIG. 1F is a long-side view of an interleaved support card bundle comprised of two pipette tip support cards, with the aprons removed, showing interleaving of the pipette tips.

FIG. 1G is a long-side view of an interleaved support card bundle comprised of two pipette tip support cards, with the aprons removed, showing interleaving of the pipette tips and a sliding lid.

FIG. 1H is a front view of an interleaved support card bundle comprised of two pipette tip support cards.

FIG. 1I is a front view of separated support cards from an interleaved support card bundle.

FIG. 1J is a top view of two support cards showing longitudinal and lateral offsets between arrays of pipette tip support holes.

FIG. 1K is a top isometric view, with an apron removed, showing pipette tips disposed in underside receiver slots.

FIG. 1L is a top isometric view, with an apron removed, showing distal ends of pipette tips from opposing cards disposed in underside receiver slots.

FIG. 2A is a top perspective exploded view of an interleaved support card bundle comprised of four pipette tip support cards.

FIG. 2B is a top exploded view of an interleaved support card bundle comprised of four pipette tip support cards.

FIG. 2C is a short-side exploded view of an interleaved support card bundle comprised of four pipette tip support cards.

FIG. 3A is a top isometric exploded view of an interleaved support card bundle comprised of six pipette tip support cards.

FIG. 3B is a top exploded view of an interleaved support card bundle comprised of six pipette tip support cards.

### DETAILED DESCRIPTION OF THE INVENTION

Reference is made herein to specific example embodiments of the invention, including presently contemplated best modes for carrying out the invention. These embodiments are illustrated in the accompanying figures. While the invention is described in connection with these specific embodiments, the embodiments are not intended to limit the invention. To the contrary, the embodiments are intended to cover alternatives, modifications, and equivalents as may be included within the spirit and scope of the invention as defined by the appended claims.

In the following description, numerous specific details are set forth to provide a thorough understanding of example embodiments. Embodiments of the invention may be implemented without some or all of these specific details. In other instances, process operations well known to persons of ordinary skill in the art are not described in detail so as not to obscure unnecessarily the present invention. Various techniques and mechanisms of the invention are sometimes described in singular form for clarity, but it will be understood that some embodiments include multiple iterations of a technique or multiple instances of a mechanism unless noted otherwise. Similarly, various steps of methods disclosed herein need not be performed in the particular order shown, or performed at all, in certain embodiments.

As used herein, the term “support card” refers to a generally planar member having a top surface with an array of pipette tip support holes configured to retain pipette tips, and a bottom surface opposite the top surface. The term “apron” refers to a wall or skirt that extends from the support card in the same direction as the pipette tips to elevate the support card above a work surface. The term “receiver slot” refers to a recess or opening formed in the bottom surface of a support card and dimensioned to receive a distal end of a pipette tip from an opposing support card with clearance. The term “multi-channel pipettor” (also sometimes referred to herein as a “multiport pipetter”) denotes a pipetting device having multiple channels or ports configured to aspirate and dispense liquid using multiple pipette tips simultaneously.

For ease of reference, the following list summarizes example features and corresponding reference numerals:

| | |
|---|---|
| Interleaved Support Card Bundle (Two Cards) | 5-1 |
| Interleaved Support Card Bundle (Four Cards) | 5-2 |
| Interleaved Support Card Bundle (Six Cards) | 5-3 |
| First Support Card | 10-1 |
| Second Support Card | 10-2 |
| Third Support Card | 10-3 |
| Fourth Support Card | 10-4 |
| Fifth Support Card | 10-5 |
| Sixth Support Card | 10-6 |
| First Apron | 12-1 |
| Second Apron | 12-2 |
| First Lid | 15-1 |
| Second Lid | 15-2 |
| Fourth Lid | 15-4 |
| Support Card Long Edge | 16-1 |
| Support Card Short Edge | 16-2 |
| Lid Sliding Direction (Long Edge) | 17-1 |
| Lid Sliding Direction (Short Edge) | 17-2 |
| First Apron Distal Edge | 18-1 |
| Second Apron Distal Edge | 18-2 |
| Apron Contact Area | 19 |
| First Top Surface | 20-1 |
| Second Top Surface | 20-2 |
| First Plurality of Pipette Tip Support Holes | 25-1 |
| Second Plurality of Pipette Tip Support Holes | 25-2 |
| First Plurality of Partial Holes | 35-1 |
| Multiport Pipetter | 40 |
| Unobstructed Region | 45 |
| First Plurality of Pipette Tips | 50-1 |
| Second Plurality of Pipette Tips | 50-2 |
| Pipette Tips Interleaved Region | 55 |
| Long Side Offset | 60-1 |
| Short Side Offse | 60-2 |
| Receiver Slot | 65-1 |
| Receiver Slot | 65-2 |

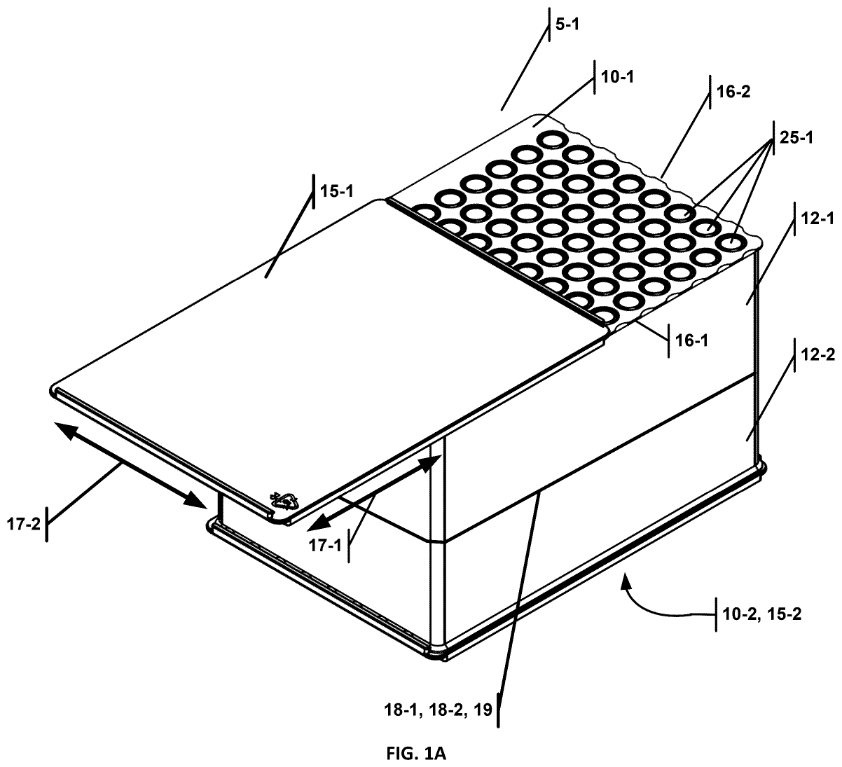

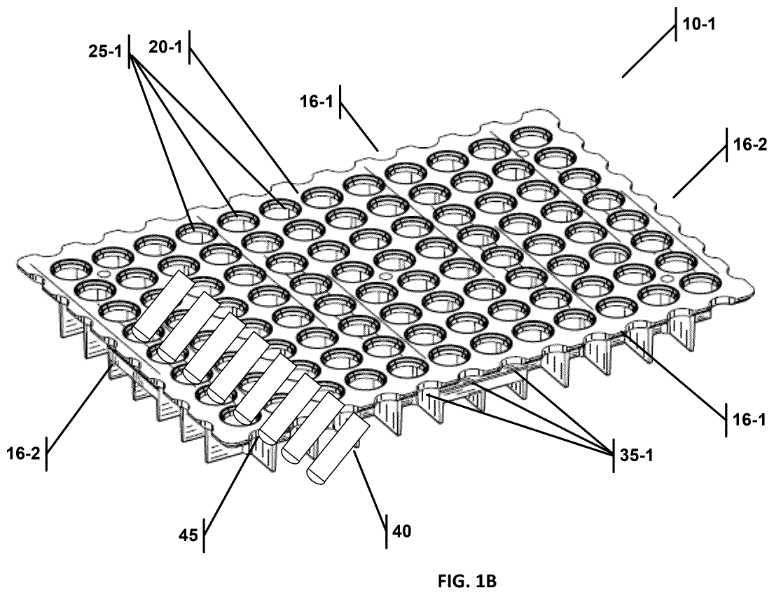

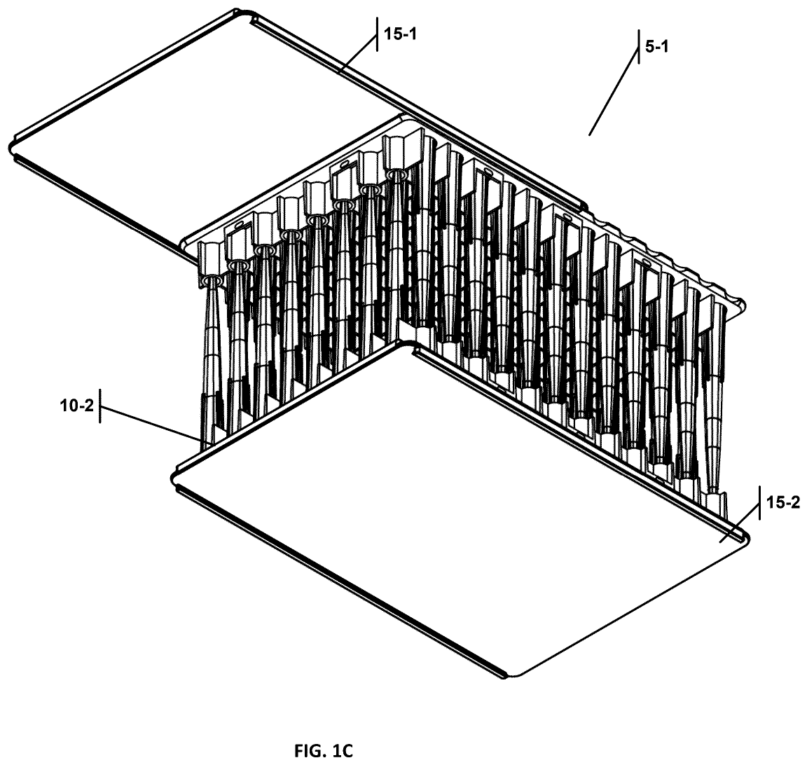

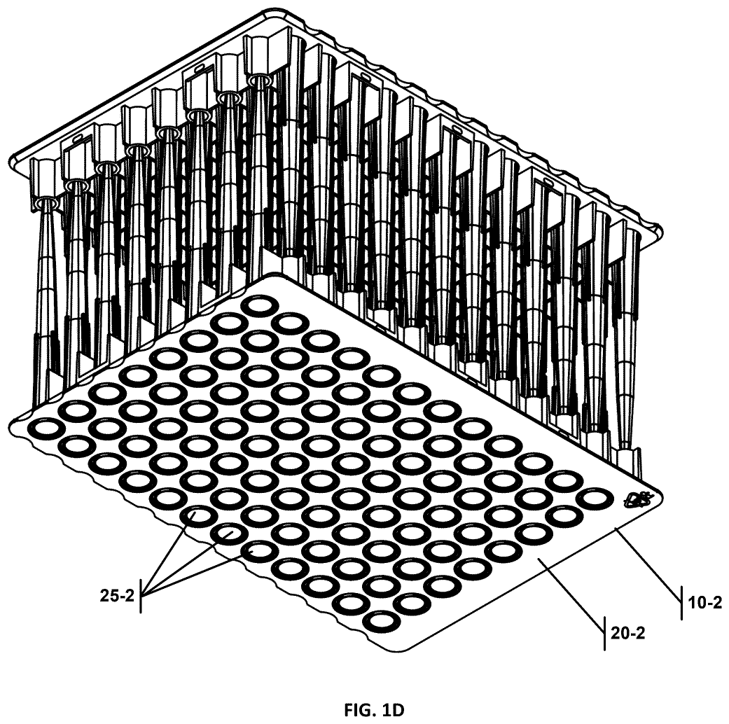

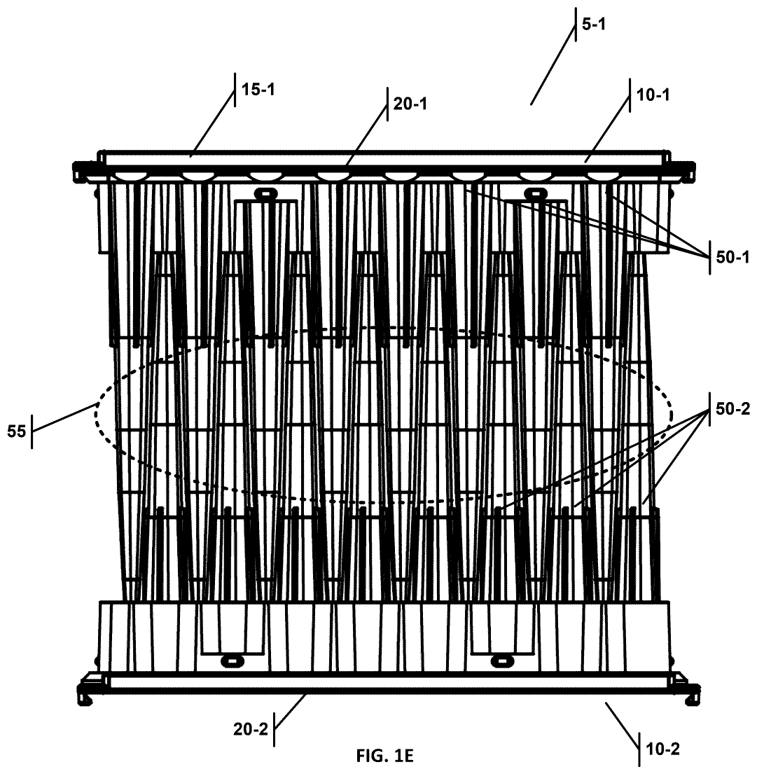

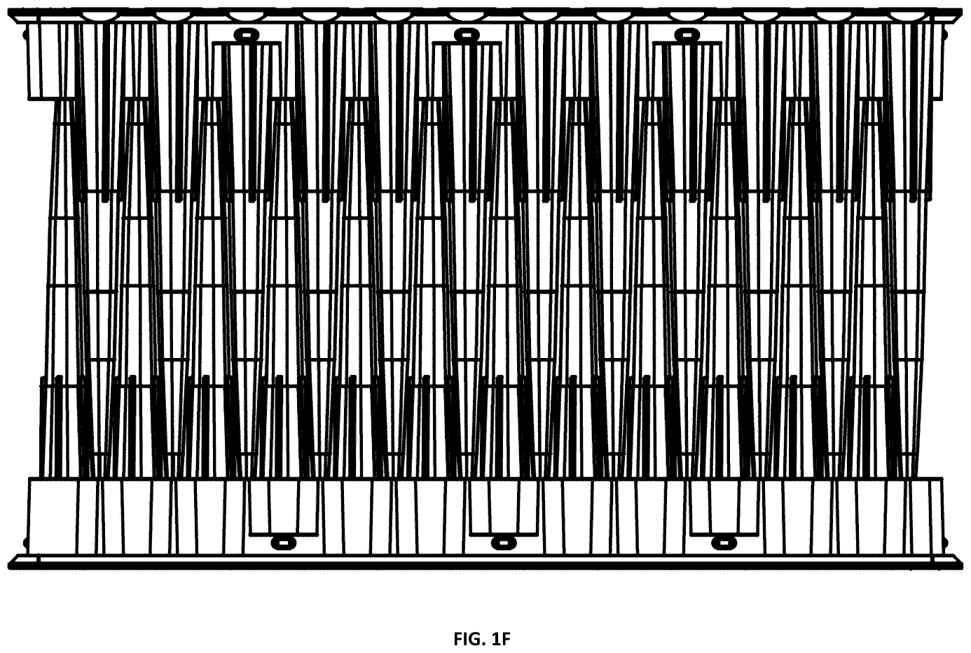

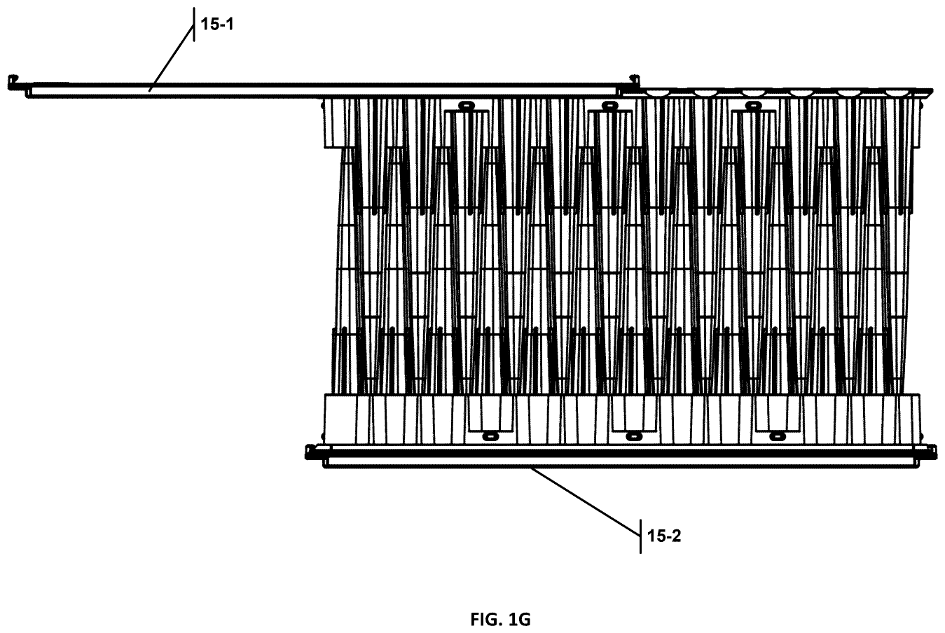

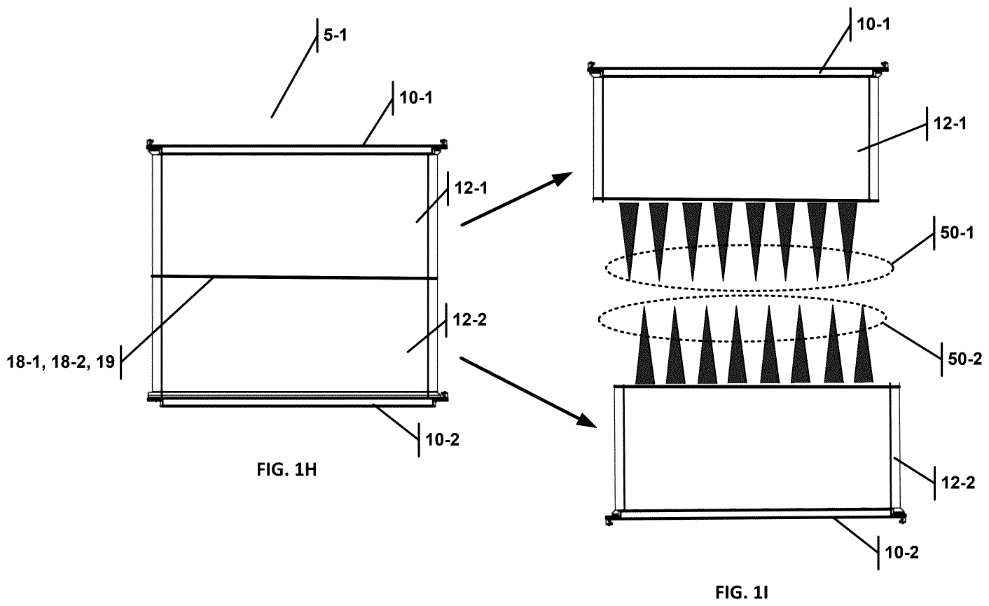

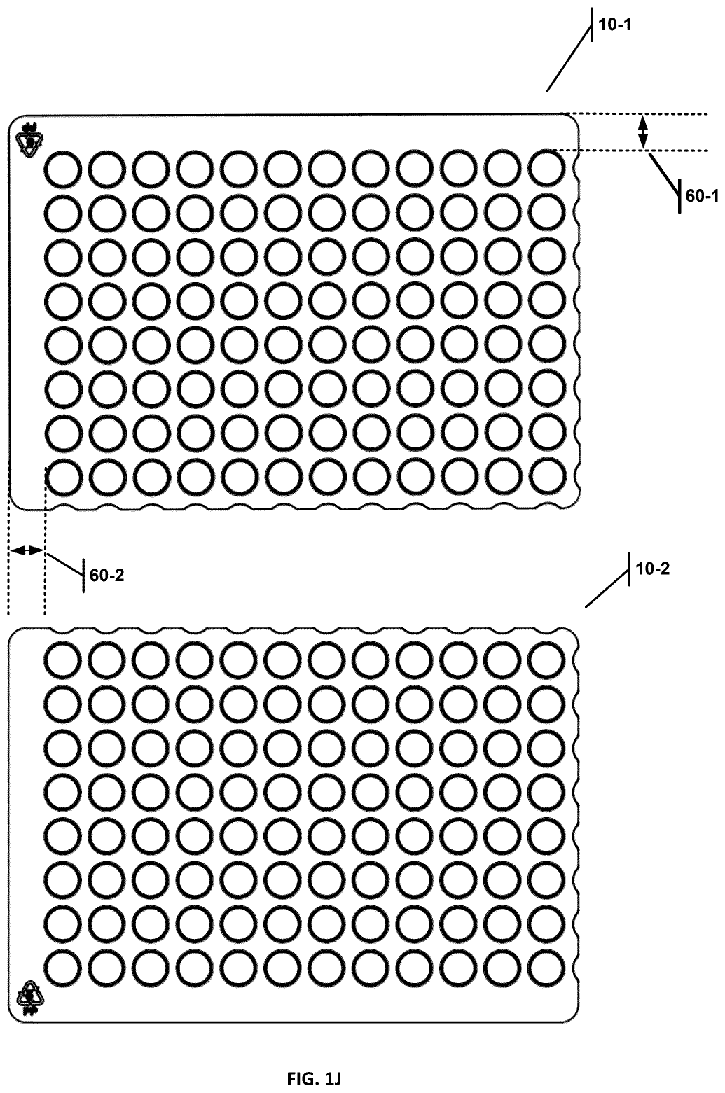

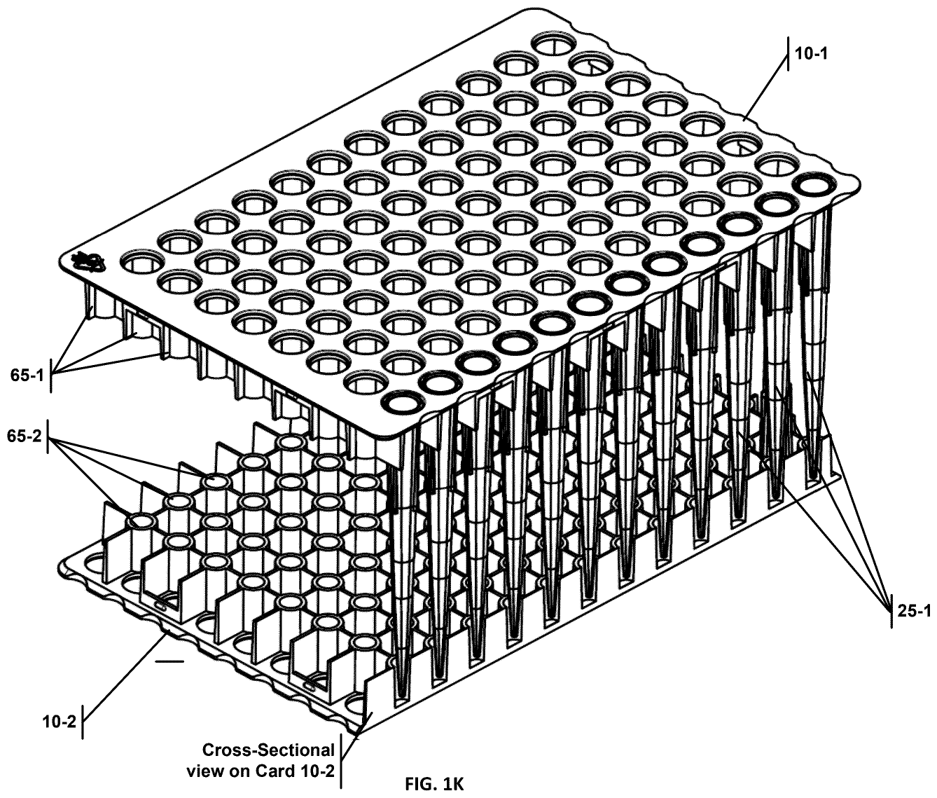

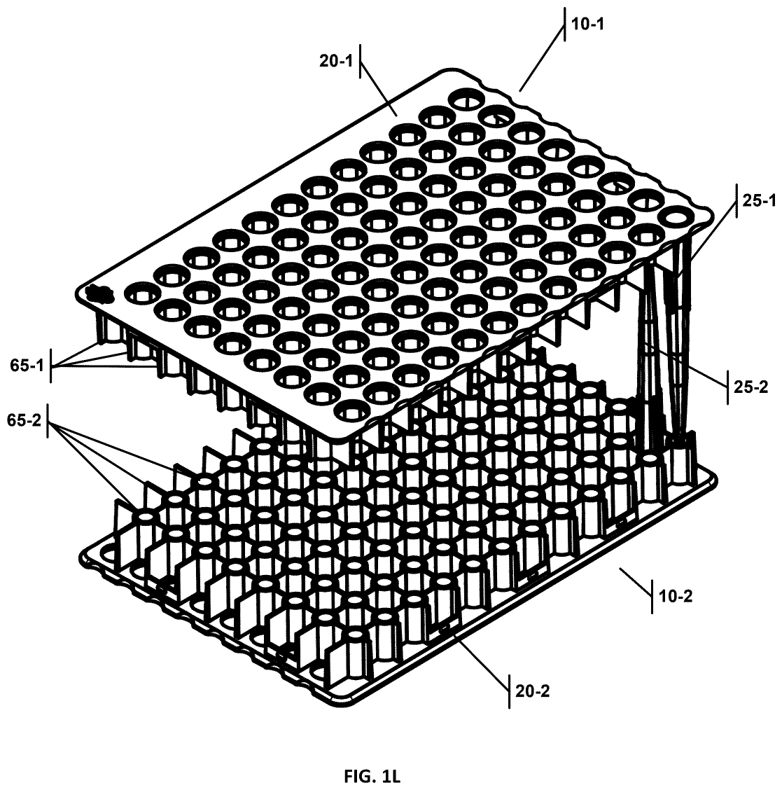

Turning now to FIGS. 1A-1L, an interleaved support card bundle 5-1 is shown comprising two pipette tip support cards 10-1 and 10-2. Each support card can be removed from the bundle 5-1 to access the pipette tips carried by that card.

The first support card 10-1 includes a first top surface 20-1 that contains a first plurality of pipette tip support holes 25-1 arranged in an array. A first plurality of pipette tips 50-1 is disposed in the support holes 25-1, and the pipette tips 50-1 extend away from the first top surface 20-1 in a first direction (see, for example, FIG. 1E).

Similarly, the second support card 10-2 includes a second top surface 20-2 containing a second plurality of pipette tip support holes 25-2 arranged in an array. A second plurality of pipette tips 50-2 is disposed in the support holes 25-2, and the pipette tips 50-2 extend away from the second top surface 20-2 in a second direction opposite the first direction.

As illustrated in FIG. 1E, the first top surface 20-1 is substantially parallel to the second top surface 20-2 when the cards are assembled as the bundle 5-1. The first plurality of pipette tips 50-1 extends toward the second top surface 20-2, and the second plurality of pipette tips 50-2 extends toward the first top surface 20-1. The pipette tips 50-1 and 50-2 interleave with one another in an interleaved region 55 without tip-to-tip contact.

FIG. 1H illustrates a first apron 12-1 connected to the first support card 10-1 and extending away from the first top surface 20-1 in the same direction as the first plurality of pipette tips 50-1. A second apron 12-2 is connected to the second support card 10-2 and extends away from the second top surface 20-2 in the same direction as the second plurality of pipette tips 50-2. The first apron terminates in a first distal edge 18-1, and the second apron terminates in a second distal edge 18-2. When the bundle 5-1 is assembled, the first and second distal edges 18-1, 18-2 contact one another at an apron contact area 19, thereby defining the spacing between the top surfaces 20-1 and 20-2.

The distance that the first apron 12-1 extends from the first top surface 20-1 is less than the extension length of the first plurality of pipette tips 50-1 such that the tips 50-1 extend beyond the first distal edge 18-1. The second apron 12-2 has a corresponding construction relative to the second plurality of pipette tips 50-2 and the second distal edge 18-2 (see FIG. 1I). The aprons thus support the cards when the bundle 5-1 rests on a flat surface while allowing maximum interleaving of the pipette tips.

In some embodiments, each support card includes a lid. For example, the first support card 10-1 may include a first lid 15-1 configured to cover the first top surface 20-1 and retain the first plurality of pipette tips 50-1 in the support holes 25-1. The first lid 15-1 may be a sliding lid configured to translate along a long edge 16-1 or a short edge 16-2 in a corresponding lid sliding direction 17-1 or 17-2, as illustrated in FIG. 1A. In other embodiments, the lid may be snap-fit or hinged as described in U.S. Pat. No. 11,701,663. The second support card 10-2 may include a second lid 15-2 with a similar construction (see FIGS. 1A and 1C).

The bundle 5-1 may be used as follows. The bundle is initially positioned such that the first top surface 20-1 is generally horizontal and facing upward. The first lid 15-1 is opened to expose the first plurality of pipette tips 50-1, and a pipettor-such as a handheld single-channel or multi-channel pipettor, an automated pipettor, or a pump-based aspiration device-aspirates one or more of the pipette tips 50-1. If desired, the second lid 15-2 may remain closed during this operation to prevent pipette tips 50-2 from dislodging from the second support card 10-2.

After at least some of the first plurality of pipette tips 50-1 have been used, the first lid 15-1 may be closed to protect any remaining tips 50-1. The bundle 5-1 is then rotated approximately 180° so that the second top surface 20-2 faces upward, the second lid 15-2 is opened, and at least some of the second plurality of pipette tips 50-2 are aspirated. When the bundle includes additional interleaved pairs (for example in bundles of four or six support cards), the user can repeat this process, rotating the bundle in 90° increments to access additional cards while keeping non-accessed cards closed to secure their tips.

FIG. 1B illustrates the first support card 10-1 removed from the bundle 5-1. A first plurality of peripheral partial holes or cutouts 35-1 is formed along at least one edge, such as the long edge 16-1. In the illustrated embodiment, cutouts 35-1 are provided along all four edges of the support card 10-1. The cutouts 35-1 define an unobstructed region 45 that permits a multi-channel pipettor 40 to access a subset of tips in a row without interference from the card edge.

By way of example, if a multi-channel pipettor 40 is configured to aspirate eight tips but only five tips in a row are to be accessed, three of the pipettor channels must pass along the edge of the support card 10-1. Without the cutouts 35-1, the edge of the card would obstruct movement of those unused channels. The cutouts 35-1 create the unobstructed region 45 so that the multi-channel pipettor 40 can move into position and access the desired subset of pipette tips. The second support card 10-2 may include a similar plurality of cutouts.

As shown in FIG. 1J, the first support card 10-1 may be formed with a long-side offset 60-1 and a short-side offset 60-2. The second support card 10-2 has a corresponding construction but is a mirror image of the first support card 10-1. The longitudinal and lateral offsets 60-1, 60-2 assist in staggering the pipette tips of opposing support cards so that they can interleave without interference.

FIG. 1K illustrates underside receiver slots 65-1 formed in the bottom surface of the first support card 10-1. Each receiver slot 65-1 is coaxially aligned with a corresponding pipette tip support hole 25-1 on the first support card 10-1 and is configured to receive the distal end of a pipette tip from the opposing support card 10-2. FIG. 1K also illustrates receiver slots 65-2 formed in the second support card 10-2, shown in cross-section. FIG. 1L illustrates distal ends of pipette tips from opposing support cards disposed in the underside receiver slots 65-1, 65-2.

The receiver slots 65-1, 65-2 are dimensioned so that the distal ends of the opposing pipette tips are received with clearance and do not contact the opposing card. The combination of interleaving, tip staggering, and receiver slots substantially prevents tip-to-tip and tip-to-card contact during shipping and handling, reducing static buildup and maintaining the pipette tips in a centered position within their support holes. This is particularly advantageous for automated pipetting systems that rely on precise alignment between the pipettor channels and the support hole array to ensure reliable tip pickup.

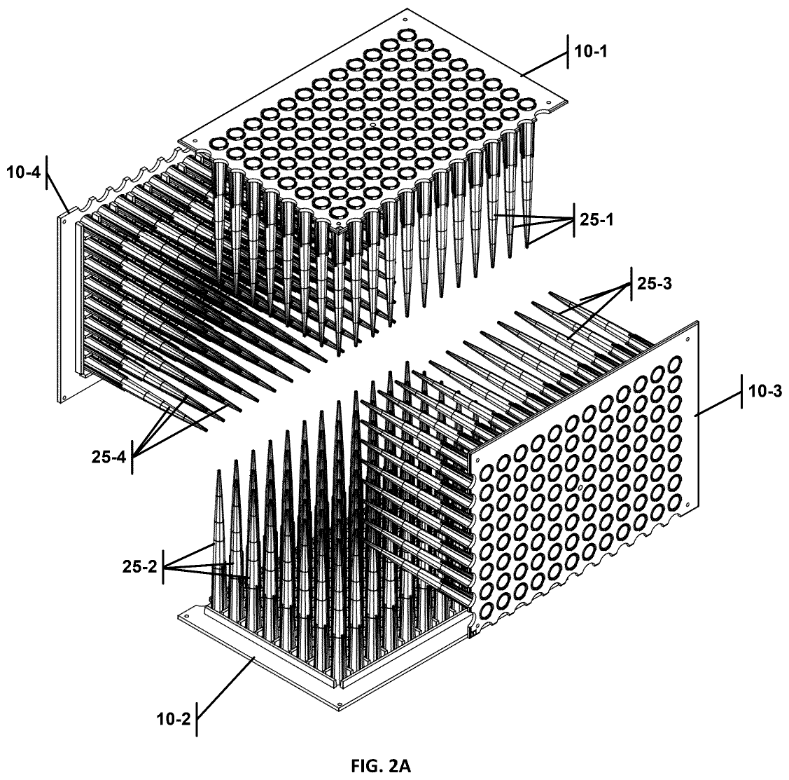

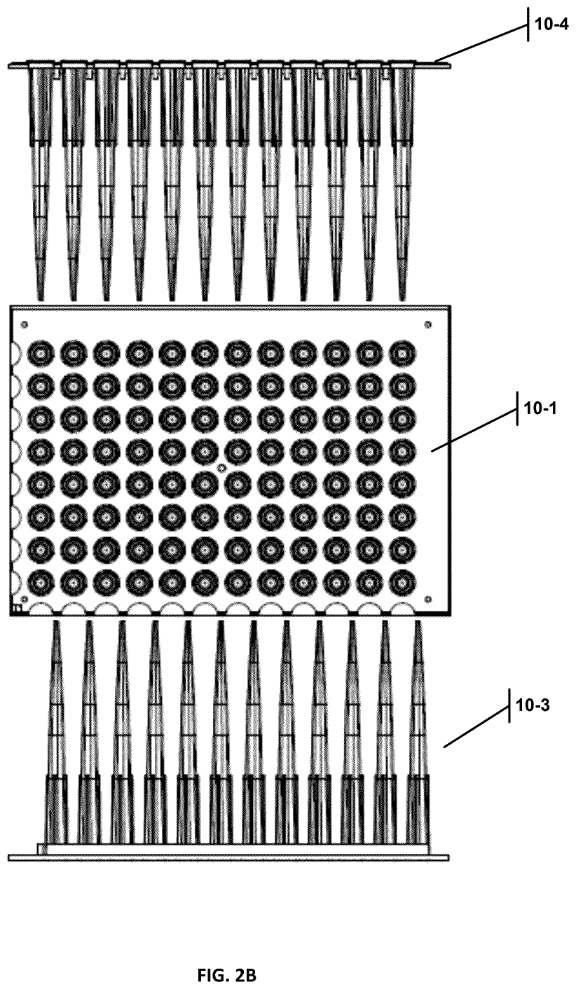

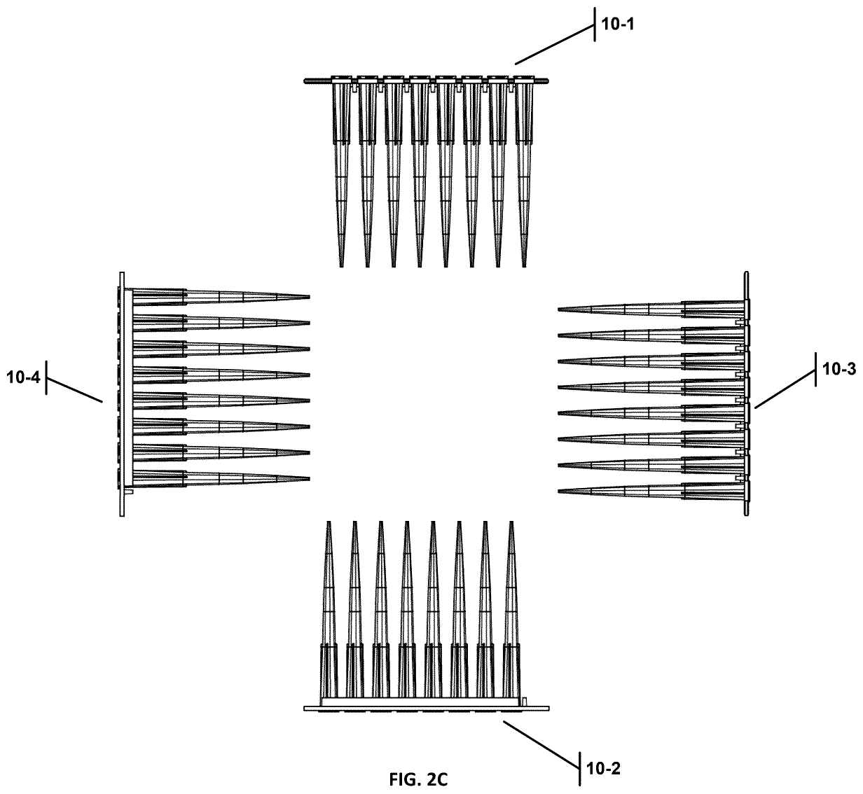

FIGS. 2A-2C illustrate an interleaved support card bundle 5-2 comprising four pipette tip support cards 10-1, 10-2, 10-3, and 10-4. The third support card 10-3 and fourth support card 10-4 may have constructions similar to that of the first support card 10-1 described above.

In the illustrated embodiment, the third support card 10-3 and the fourth support card 10-4 form a second interleaved pair in which the top surface of the third support card 10-3 is substantially parallel to the top surface of the fourth support card 10-4. Pipette tips carried by the third support card 10-3 extend toward the top surface of the fourth support card 10-4, and pipette tips carried by the fourth support card 10-4 extend toward the top surface of the third support card 10-3, interleaving without contact as described for the first pair.

The pair of support cards 10-3 and 10-4 is oriented substantially orthogonally to the pair of support cards 10-1 and 10-2, for example rotated by about 90° about a central axis of the bundle 5-2. This arrangement allows four fully loaded support cards to be packed into a compact, generally cubic bundle that is only slightly taller than one conventional support card plus one tip length. A user can access pipette tips from any card by rotating the bundle 5-2 to bring the desired top surface into an upward-facing, accessible orientation and opening the corresponding lid, if present.

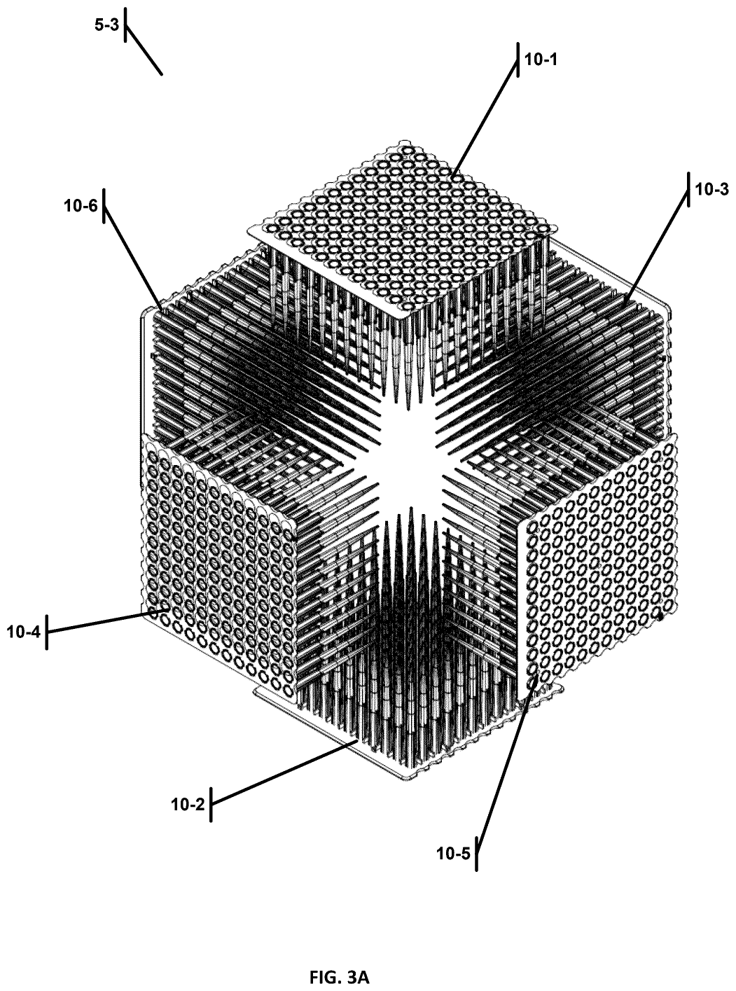

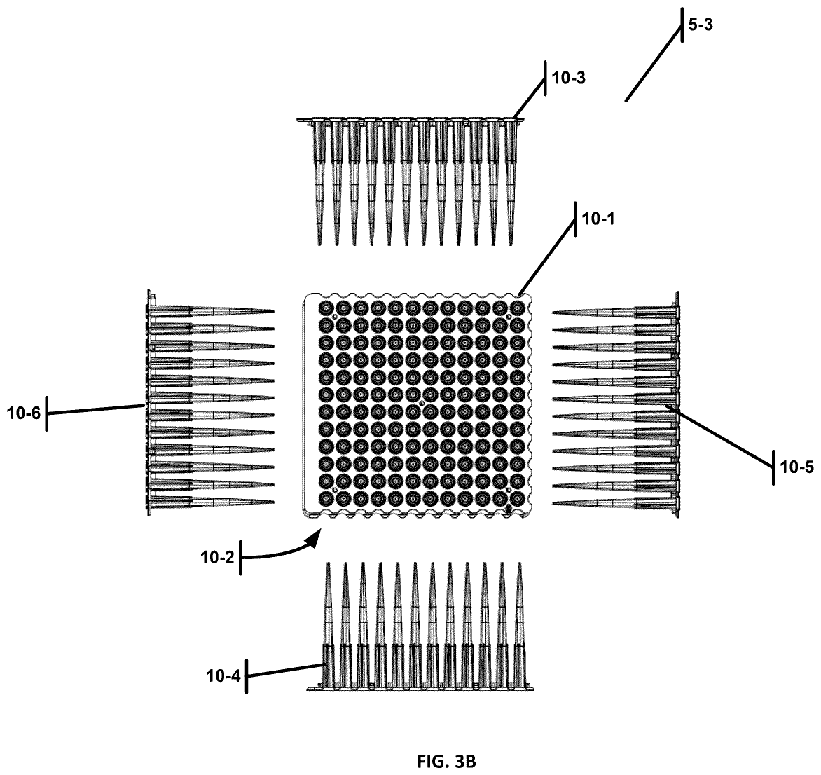

FIGS. 3A and 3B illustrate an interleaved support card bundle 5-3 comprising six pipette tip support cards 10-1, 10-2, 10-3, 10-4, 10-5, and 10-6. The fifth support card 10-5 and sixth support card 10-6 may again have constructions similar to that of the first support card 10-1.

In this embodiment, the fifth support card 10-5 and the sixth support card 10-6 form a third interleaved pair in which the top surface of the fifth support card 10-5 is substantially parallel to the top surface of the sixth support card 10-6. Pipette tips supported by the fifth support card 10-5 extend toward the top surface of the sixth support card 10-6, and pipette tips supported by the sixth support card 10-6 extend toward the top surface of the fifth support card 10-5, interleaving without contact as described above.

The three interleaved pairs (10-1/10-2, 10-3/10-4, and 10-5/10-6) are oriented substantially orthogonally to one another to form a compact multi-pair bundle 5-3. As with the four-card bundle 5-2, the bundle 5-3 can be rotated in 90° increments to sequentially access the pipette tips carried by each support card while keeping non-accessed cards closed to protect their tips.

The foregoing description of embodiments is provided to enable any person skilled in the art to make and use the invention. Various modifications to these embodiments will be readily apparent to those skilled in the art, and the generic principles described herein can be applied to other embodiments without departing from the spirit or scope of the invention. Accordingly, the described and illustrated embodiments are to be considered representative and not limiting. The scope of the invention is defined solely by the appended claims. ference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that they are not intended to limit the invention to the described or illustrated embodiments. To the contrary, they are intended to cover alternatives, modifications, and equivalents as may be included within the spirit and scope of the invention as defined by the appended claims.

1. An interleaved pipette tip support card bundle comprising:
a first pipette tip support card (10-1) having a first top surface (20-1) with a first array of pipette tip support holes (25-1);
a first plurality of pipette tips (50-1) retained in the first array of pipette tip support holes and extending away from the first top surface in a first direction;
a second pipette tip support card (10-2) having a second top surface (20-2) with a second array of pipette tip support holes (25-2);
a second plurality of pipette tips (50-2) retained in the second array of pipette tip support holes and extending away from the second top surface in a second direction opposite the first direction;
a first apron (12-1) extending from the first pipette tip support card in the first direction a distance less than an extension length of the first plurality of pipette tips and terminating in a first distal edge (18-1); and
a second apron (12-2) extending from the second pipette tip support card in the second direction a distance less than an extension length of the second plurality of pipette tips and terminating in a second distal edge (18-2) that abuts the first distal edge,
wherein the first and second top surfaces are parallel and spaced apart, the first and second pluralities of pipette tips interleave without contacting one another, and each of the first and second pipette tip support cards comprises a plurality of receiver slots (65-1, 65-2) in a bottom surface of the card, the receiver slots being coaxially aligned with pipette tip support holes of the opposing card and configured to receive distal ends of pipette tips from the opposing card with clearance such that the distal ends do not contact the opposing card.

2. The bundle of claim 1, wherein the first and second arrays of pipette tip support holes are offset both longitudinally (60-1) and laterally (60-2) relative to one another.

3. The bundle of claim 1, further comprising first and second lids (15-1, 15-2) that cover the respective top surfaces, each lid being a sliding, snap-fit, or hinged lid configured to secure the pipette tips in their support holes.

4. The bundle of claim 1, wherein at least one pipette tip support card comprises a plurality of peripheral cutouts or partial holes (35-1) along at least one edge defining an unobstructed region (45) that permits a multi-channel pipettor (40) to access a partial row of pipette tips without interference from the support card edge.

5. The bundle of claim 1, wherein the first and second pipette tip support cards are formed from an anti-static or static-dissipative polymer.

6. An interleaved pipette tip support card bundle comprising at least four support cards arranged as at least two interleaved pairs according to claim 1, the at least two pairs being oriented substantially orthogonally to one another within the bundle.

7. The bundle of claim 6, comprising exactly four support cards (5-2).

8. The bundle of claim 6, comprising exactly six support cards (5-3) arranged as three substantially orthogonal interleaved pairs.

9. A method of using an interleaved pipette tip support card bundle according to claim 4, the method comprising:
(a) positioning the bundle such that the first top surface is generally horizontal and facing upward;
(b) opening a first sliding lid to expose the first plurality of pipette tips;
(c) aspirating at least some of the first plurality of pipette tips with a pipettor;
(d) closing the first sliding lid;
(e) rotating the bundle approximately 180° so that the second top surface is generally horizontal and facing upward;
(f) opening the second sliding lid; and
(g) aspirating at least some of the second plurality of pipette tips with the pipettor.

10. The method of claim 9, further comprising repeating steps (a)-(g) with additional interleaved pairs of support cards by rotating the bundle in approximately 90° increments when the bundle contains four or six support cards.

11. An interleaved pipette tip support card bundle comprising:
a plurality of pipette tip support cards, each pipette tip support card having a top surface with an array of pipette tip support holes and a bottom surface with a plurality of receiver slots coaxially aligned with the support holes, each pipette tip support card carrying a plurality of pipette tips extending away from its top surface;
wherein the plurality of pipette tip support cards are arranged such that the top surfaces face outwardly and the pipette tips of each card extend inwardly and interleave with pipette tips of an opposing card, distal ends of the pipette tips being received in the receiver slots of the opposing card without tip-to-tip contact and without the distal ends contacting the opposing card.

12. The interleaved pipette tip support card bundle of claim 11, wherein the arrays of pipette tip support holes on opposing cards are offset both longitudinally and laterally relative to one another.

13. The interleaved pipette tip support card bundle of claim 11, comprising exactly two, exactly four, or exactly six pipette tip support cards.
